(19) United States
(12) Patent Application Publication
(10) Pub. No.: US 2016/0173566 A1
(43) Pub. Date: Jun. 16, 2016

(54) Method and a Device thereof for Monitoring the File Uploading via an Instrument

(71) Applicant: Xinyu Xingbang Information Industry Co., Ltd, Xinyu (CN)

(72) Inventors: Xiaohong Yao, Foshan (CN); Zhihong Zhou, Shaoyang (CN)

(73) Assignee: Xinyu Xingbang Information Industry Co., Ltd

(21) Appl. No.: 14/729,021

(22) Filed: Jun. 2, 2015

(30) Foreign Application Priority Data
Dec. 16, 2014 (CN) 201410785261.9

(51) Int. Cl. H04L 29/08

(52) U.S. Cl. CPC H04L 67/06

(57) ABSTRACT

The invention discloses a method and a device thereof for monitoring the file uploading via an instrument; the method comprises: selecting a file; acquiring file information, setting the maximum value of a panel and displaying the metadata of the file; judging whether the file size is smaller than a first preset value, if so, uploading the file to a server, updating the instrument progress; otherwise, judging whether the file size is larger than the first preset value and smaller than a second preset value, if so, compressing and uploading the file, updating the instrument progress; otherwise, segmenting the file for the multithreaded uploading, updating the instrument progress of various file segments, thus completing file uploading. The invention has the following beneficial effects: the file information is displayed in a user-friendly way, the interaction interface is excellent enough and experience of the user is enhanced.

### CROSS-REFERENCE TO RELATED APPLICATIONS

The present application claims the benefit of Chinese Patent Application No. 201410785261.9 filed on Dec. 16, 2014, the entire content of which is hereby incorporated by reference.

### FIELD OF THE INVENTION

The invention relates to the field of file uploading, and in particular relates to a method and a device thereof for monitoring the file uploading via an instrument.

### BACKGROUND OF THE INVENTION

Traditionally, the file uploading progress is monitored by a monotonous and simple progress bar; the file information (including such notification information as the file type, the file size, the creating date and the like) is not displayed in a user-friendly way, and it is not friendly when the user wants to search the detailed information of the file; and no excellent interaction interface is offered for the compressed uploading, the uploading within seconds and the multithreaded uploading of the file; therefore, resulting in a quite poor experience of the user.

### SUMMARY OF THE INVENTION

In order to solve the technical problems of the prior art that the file information cannot be displayed in a user-friendly way, the interaction interface is not good enough and experience of the user is poor, the invention provides a method and a device thereof for monitoring the file uploading via an instrument, by which the file information is displayed in a user-friendly way, the interaction interface is excellent enough and experience of the user is enhanced.

The technical solution of the invention to solve the technical problems as follows: construct a method for monitoring the file uploading via an instrument, wherein, the instrument comprises a setting area for setting parameters, an instrument panel area for displaying the file uploading progress, a file uploading success status area for displaying the file uploading status and a file information area for displaying the file information; wherein, the method comprises the following steps:

A) Selecting a file to be uploaded by the user;

B) Acquiring the information of the file via an instrument, setting the maximum value of the panel according to the file size, and simultaneously displaying the metadata of the file;

C) Judging whether the file size is smaller than a first preset value, if so, executing step D), otherwise, executing step E);

D) Directly uploading the file to the server from the user terminal and monitoring the bytes transmitted by the file to update the progress displayed in the instrument panel area; returning the uploading success information after the server receiving the file, and executing step H);

E) Judging whether the file size is larger than the first preset value and smaller than a second preset value, if so, executing step F), otherwise, executing step G);

F) Compressing and uploading the file by the user terminal, and monitoring the bytes transmitted by the compressed file to update the progress displayed in the instrument panel area; after the server receiving the file, decompressing the compressed file, returning the uploading success information and executing step H);

G) Segmenting the file for the multithreaded uploading, and updating the progress of various file segments displayed in the instrument panel area according to the bytes transmitted by each file segment; after the server receiving the file, returning the uploading success information to the user terminal and executing step H);

H) Updating the status information in the file uploading success status area by the user terminal, thus completing file uploading.

According to the method for monitoring the file uploading via an instrument of the invention, the step D) further comprises:

D1) Transmitting a request to the server from the user terminal;

D2) Transmitting the file to the server from the user terminal;

D3) Monitoring the bytes transmitted by the file from the user terminal in real time and updating the uploading progress displayed in the instrument panel area;

D4) Receiving the file by the server, and returning the uploading success information to the user terminal.

According to the method for monitoring the file uploading via an instrument of the invention, the step F) further comprises:

F1) Compressing the file to obtain a compressed file, then transmitting the compressed file to the server, and simultaneously updating the instrument;

F2) Transmitting a request to the server from the user terminal and informing the server to start the compressed uploading;

F3) Creating the received temporary file by the server and returning the uploading path to the user terminal;

F4) After receiving the uploading path by the user terminal, loading the compressed file and uploading the compressed file in accordance with the uploading path;

F5) Monitoring the bytes transmitted by the compressed file in the user terminal, and updating the uploading progress displayed in the instrument panel area;

F6) Receiving the compressed file by the server, decompressing the compressed file and returning the uploading success information to the user terminal.

According to the method for monitoring the file uploading via an instrument of the invention, the step G) further comprises:

G1) Segmenting the file for the multithreaded uploading, and updating the instrument;

G2) Transmitting a request to the server from the user terminal, and informing the server to start the multithreaded uploading;

G3) Creating multiple threads and temporary files according to the file size by the server, and returning the multiple uploading links;

G4) Creating the user terminal threads by the user terminal according to the multiple uploading links, loading and uploading the multiple file segments;

G5) Monitoring the bytes transmitted by the various file segments by the user terminal, and updating the uploading progress of the multiple file segments displayed in the instrument panel area;

G6) Returning the uploading success information to the user terminal from the server after having received a file segment;

G7) Transmitting the metadata of the file to the server from the user terminal after having received the uploading success information of all file segments;

G8) After the server receiving the metadata, integrating all file segments, and returning the final address of the uploaded file to the user terminal.

According to the method for monitoring the file uploading via an instrument of the invention, the first preset value is 5M and the second preset value is 20M; the metadata include the file type, the file size and the creating date.

Furthermore, the invention relates to a device for implementing the method for monitoring the file uploading via an instrument; the instrument comprises a setting area for setting parameters, an instrument panel area for displaying the file uploading progress, a file uploading success status area for displaying the file uploading status and a file information area for displaying the file information; the device comprises:

A file selecting unit: for selecting a file to be uploaded by the user;

An information acquiring unit: for acquiring the information of the file via instrument, setting the maximum value of the panel according to the file size, and simultaneously displaying the metadata of the file;

A first preset value judging unit: for judging whether the file size is smaller than a first preset value;

A file uploading unit: for directly uploading the file to the server from the user terminal and monitoring the bytes transmitted by the file to update the progress displayed in the instrument panel area; returning the uploading success information after the server receiving the file;

An intermediate value judging unit: for judging whether the file size is larger than the first preset value and smaller than a second preset value;

A compressed file uploading unit: for compressing and uploading the file by the user terminal, and monitoring the bytes transmitted by the compressed file to update the progress displayed in the instrument panel area; after the server receiving the file, decompressing the compressed file, and returning the uploading success information;

A segmented uploading unit: for segmenting the file for the multithreaded uploading, and updating the progress of various file segments displayed in the instrument panel area according to the bytes transmitted by each file segment; after the server receiving the file, returning the uploading success information to the user terminal;

An updating unit: for updating the status information in the file uploading success status area by the user terminal, thus completing file uploading.

According to the device for implementing the method for monitoring the file uploading via an instrument of the invention, the file uploading unit further comprises:

A request module: for transmitting a request to the server from the user terminal;

A transmitting module: for transmitting the file to the server from the user terminal;

A monitoring and updating module: monitoring the bytes transmitted by the file by the user terminal in real time and updating the uploading progress displayed in the instrument panel area;

A receiving and returning module: for receiving the file via the server, and returning the uploading success information to the user terminal.

According to the device for implementing the method for monitoring the file uploading via an instrument of the invention, the compressed file uploading unit further comprises:

A compressing and updating module: for compressing the file to obtain a compressed file, transmitting the compressed file to the server, and simultaneously updating the instrument;

A compression informing module: for transmitting a request to the server from the user terminal and informing the server to start the compressed uploading;

A temporary file creating module: for creating the received temporary file via the server and returning the uploading path to the user terminal;

A compressed file loading module: for loading and uploading the compressed file in accordance with the uploading path, after receiving the uploading path by the user terminal;

A compressed file transmitting module: for monitoring the bytes transmitted by the compressed file in the user terminal, and updating the uploading progress displayed in the instrument panel area;

A decompressing module: for receiving the compressed file by the server, decompressing the compressed file and returning the uploading success information to the user terminal.

According to the device for implementing the method for monitoring the file uploading via an instrument of the invention, the segmented uploading unit further comprises:

A multithread uploading module: for segmenting the file for the multithreaded uploading, and updating the instrument;

A multithread informing module: for transmitting a request to the server from the user terminal, and informing the server to start the multithreaded uploading;

A multithread creating module: for creating multiple threads and temporary files according to the file size by the server, and returning the multiple uploading links;

A segmented file loading module: for creating the user terminal threads by the user terminal according to the multiple uploading links, loading and uploading the multiple file segments;

A segmented file monitoring module: for monitoring the bytes transmitted by the various file segments by the user terminal, and updating the uploading progress of the multiple file segments displayed in the instrument panel area;

A segmented file receiving and returning module: for returning the uploading success information to the user terminal from the server after having received a file segment;

A metadata transmitting module: for transmitting the metadata of the file to the server from the user terminal after having received the uploading success information of all file segments;

An integrating module: for integrating all file segments after the server receiving the metadata, and returning the final address of the uploaded file to the user terminal.

According to the device for implementing the method for monitoring the file uploading via an instrument of the invention, the first preset value is 5M and the second preset value is 20M; the metadata include the file type, the file size and the creating date.

The device implementing the method for monitoring the file uploading via an instrument has the following beneficial effects: since the instrument comprises a setting area for setting parameters, an instrument panel area for displaying the file uploading progress, a file uploading success status area for displaying the file uploading status and a file information area for displaying file information, the user can directly observe the file uploading progress via the instrument panel area, preview the file information via the file information area and observe the file uploading success information via the file uploading success status area; therefore, the file information is displayed in a user-friendly manner, the interaction interface is good enough and experience of the user is enhanced accordingly.

### BRIEF DESCRIPTION OF THE DRAWINGS

In order to clearly illustrate the technical schemes of the embodiments of the invention, the drawings of the embodiments will be briefly described in the following; it is obvious that the described drawings are only related to some embodiments of the invention; for those skilled in the art, on the precondition of not making creative efforts, other attached drawings can be obtained based on the attached drawings below.

FIG. 1 is a flow chart of the method in one embodiment of the method and the device thereof for monitoring the file uploading via an instrument;

FIG. 2 is a structural schematic diagram of the instrument in the embodiment;

FIG. 3 is a specific flow chart of directly uploading the file to the server from the user terminal, monitoring the bytes transmitted by the file to update the progress displayed in the instrument panel area and returning the uploading success information after the server receiving the file according to the embodiment;

FIG. 4 is a specific flow chart of uploading the compressed file by the user terminal, monitoring the bytes transmitted by the compressed file to update the progress displayed in the instrument panel area, decompressing the compressed file after the server receiving the file and returning the uploading success information according to the embodiment;

FIG. 5 is a specific flow chart of segmenting the file for the multithreaded uploading, updating the progress of various file segments displayed in the instrument panel area according to the bytes transmitted by each file segment and returning the uploading success information to the user terminal after the server receiving the file according to the embodiment;

FIG. 6 is a structural schematic diagram of the device in the embodiment.

### DESCRIPTION OF THE PREFERRED EMBODIMENTS

In order to make clear the objects, technical details and advantages of the embodiments of the invention, the technical schemes of the embodiments will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiments, without any inventive efforts, which should be within the protection scope of the invention.

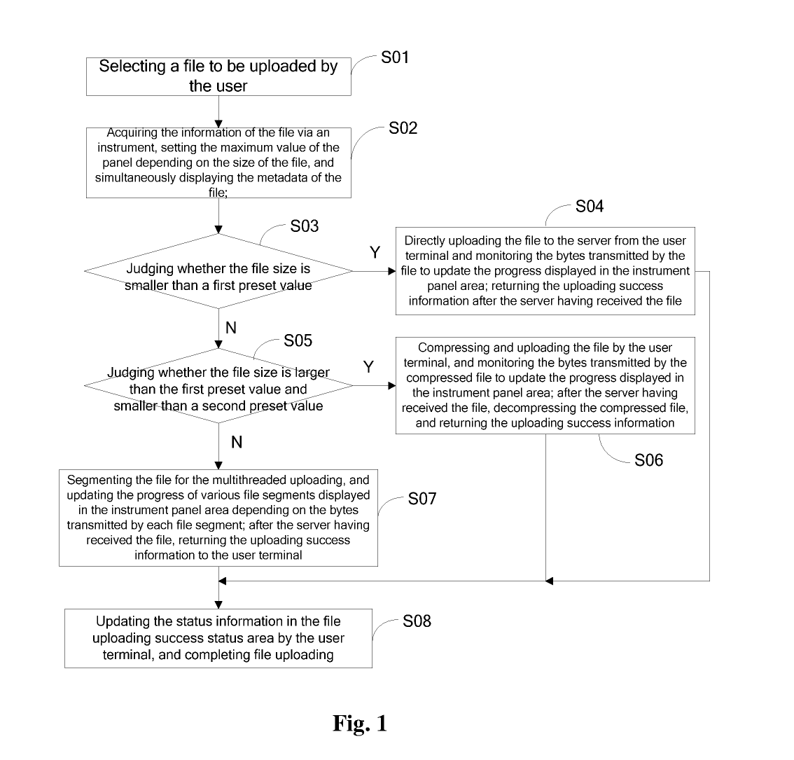

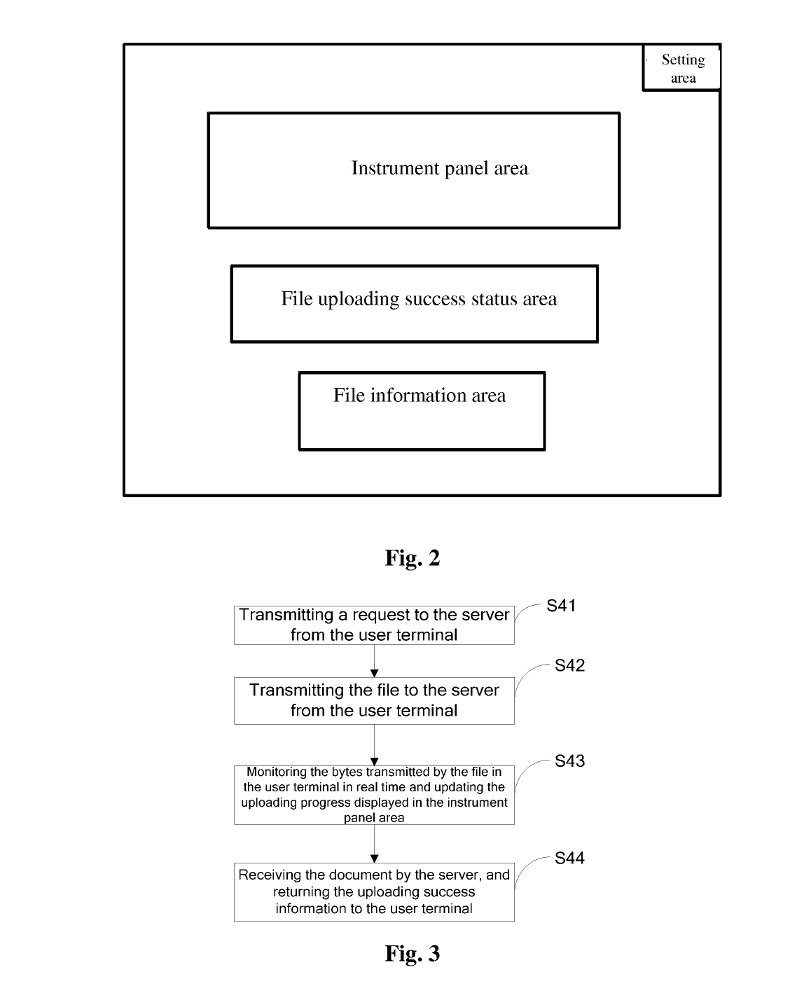

According to the embodiment of the method and the device thereof for monitoring the file uploading via an instrument, the flow chart of the method for monitoring the file uploading via an instrument is as shown in FIG. 1. And FIG. 2 is a structural schematic diagram of the instrument in the embodiment, the instrument comprises a setting area, an instrument panel area, a file uploading success status area and a file information area, wherein the setting area is used for setting parameters; the instrument panel area is used for displaying the file uploading progress; the file uploading success status area is used for displaying the file uploading status; the file information area is used for displaying file information. As shown in FIG. 1, the method for monitoring the file uploading via an instrument comprises the following steps:

Step S01: selecting a file to be uploaded by the user: in this step, the user selects file to be uploaded.

Step S02: acquiring the information of the file via the instrument, setting the maximum value of the panel according to the file size, and simultaneously displaying the metadata of the file: in this step, the instrument acquires the information of the file, sets the maximum value of the panel according to the file size, and simultaneously displays metadata of the file. The metadata of the file includes the file type, the file size, the creating date, etc. It is worth mentioning that corresponding to different file sizes, the maximum values of the panel setting vary as well.

Step S03: judging whether the file size is smaller than a first preset value: in this step, it judges whether the file size is smaller than a first preset value, if so, executes step S04, otherwise, executes step S05. It is worth mentioning that the first preset value is 5M in this embodiment. Certainly, under some circumstances of the embodiment, the first preset value can be regulated according to the specific circumstances.

Step S04: directly uploading the file to the server from the user terminal and monitoring the bytes transmitted by the file to update the progress displayed in the instrument panel area, and returning the uploading success information after the server receiving the file: if the judgment result of the step S03 is positive, executing this step. In this step, the user terminal directly uploads the file to the server from, during which the user terminal monitors the bytes transmitted by the file and updates the progress displayed in the instrument panel area, and returns the uploading success information after the server receiving the file. At end of this step, executes step S08.

Step S05: judging whether the file size is larger than the first preset value and smaller than a second preset value: if the judgment result of the step S03 is negative, executes this step. In this step, it judges whether the file size is larger than the first preset value and smaller than a second preset value, if so, executes step S06, otherwise, executes step S07. It is worth mentioning that the second preset value is 20M in this embodiment. Certainly, under some circumstances of the embodiment, the second preset value can be regulated according to the specific circumstances.

Step S06: compressing and uploading the file by the user terminal, and monitoring the bytes transmitted by the compressed file to update the progress displayed in the instrument panel area; after the server receiving the file, decompressing the compressed file and returning the uploading success information: if the judgment result of the step S05 is positive, executes this step. In this step, it compresses and uploads the file by the user terminal, and monitors the bytes transmitted by the compressed file to update the progress displayed in the instrument panel area, after the server receiving the file, decompresses the compressed file and returns the uploading success information. After this step, executes step S08.

Step S07: segmenting the file for the multithreaded uploading, and updating the progress of various file segments displayed in the instrument panel area according to the bytes transmitted by each file segment; after the server receiving the file, returning the uploading success information to the user terminal: if the judgment result of the step S05 is negative, execute this step. In this step, it segments the file for the multithreaded uploading, and updates the progress of various file segments displayed in the instrument panel area according to the bytes transmitted by each file segment, after the server receiving the file, returns the uploading success information to the user terminal. After this step, executes step S08.

Step S08: updating the status information in the file uploading success status area by the user terminal, and completing file uploading: in this step, it updates the status information in the file uploading success status area by the user terminal to display the information that file is successfully uploaded, thus completing file uploading. By virtue of the instrument, the user can directly observe the file uploading progress via the instrument panel area, preview the file information via the file information area and observe the file uploading success information via the file uploading success status area; therefore, the file information is displayed in a user-friendly manner, the interaction interface is good enough and experience of the user is enhanced accordingly.

According to the embodiment, step S04 can be further detailed, and the detailed flow chart is as shown in FIG. 3. Step S04 further comprises:

Step S41: transmitting a request to the server from the user terminal: in this step, the user terminal transmits request to the server.

Step S42: transmitting the file to the server from the user terminal: in this step, the user terminal transmits the selected file to the server.

Step S43: monitoring the bytes transmitted by the file by the user terminal in real time and updating the uploading progress displayed in the instrument panel area: in this step, the user terminal monitors the bytes transmitted by the file in real time and updates the uploading progress displayed in the instrument panel area according to the bytes transmitted by the file. Therefore, the user can observe the file uploading progress in real time, thus presenting the user a better experiencing.

Step S44: receiving the file by the server, and returning the uploading success information to the user terminal: in this step, after having received the file, the server returns the uploading success information to the user terminal. After this step, executes step S08.

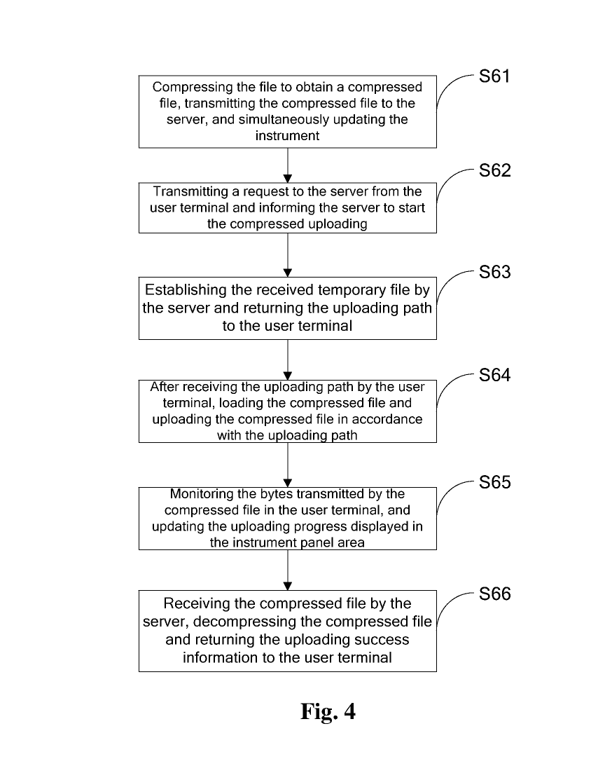

According to the embodiment, step S06 can be further detailed, and the detailed flow chart is as shown in FIG. 4. Step S06 further comprises:

Step S61: compressing the file to obtain a compressed file, transmitting the compressed file to the server, and simultaneously updating the instrument: in this step, the selected file is compressed to obtain a compressed file, the compressed file is transmitted to the server, and simultaneously the instrument is updated. It is worth mentioning that the compressed file can be in “zip” format or “rar” format.

Step S62: transmitting a request to the server from the user terminal and informing the server to start the compressed uploading: in this step, the user terminal transmits a request to the server and informs the server transmits the file by the way of the compressed uploading.

Step S63: creating the received temporary file by the server and returning the uploading path to the user terminal: in this step: the server establishes the received temporary file and returns the uploading path to the user terminal.

Step S64: after receiving the uploading path by the user terminal, loading and uploading the compressed file in accordance with the uploading path: in this step, the user terminal receives the uploading path, loads and uploads the compressed file in accordance with the uploading path.

Step S65: monitoring the bytes transmitted by the compressed file in the user terminal, and updating the uploading progress displayed in the instrument panel area: in this step, the user terminal monitors the bytes transmitted by the compressed file and updates the uploading progress displayed in the instrument panel area.

Step S66: receiving the compressed file by the server, decompressing the compressed file and returning the uploading success information to the user terminal: in this step, the server receives the compressed file, decompresses the compressed file and returns the uploading success information to the user terminal. According to the embodiment, when the file size ranges from 5M to 20M, the uploading speed can be accelerated by compressing the file and uploading the compressed file. After this step, executes step S08.

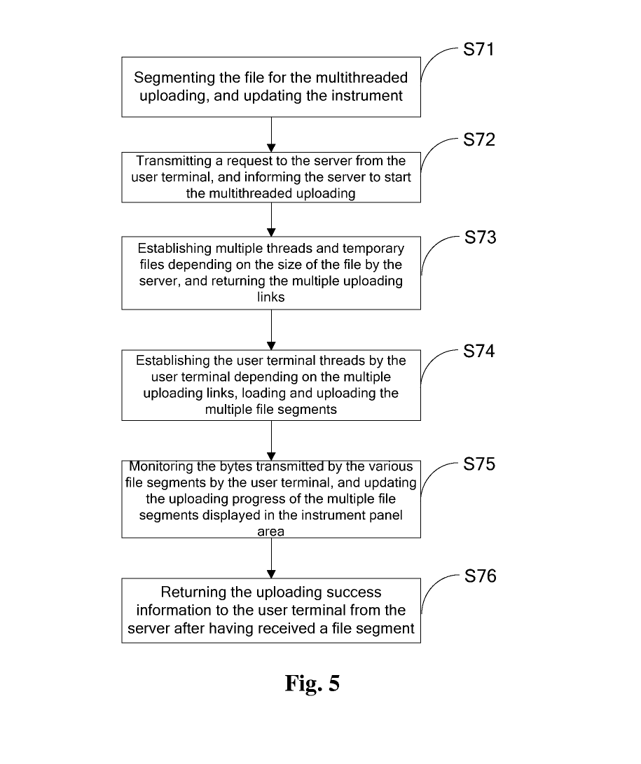

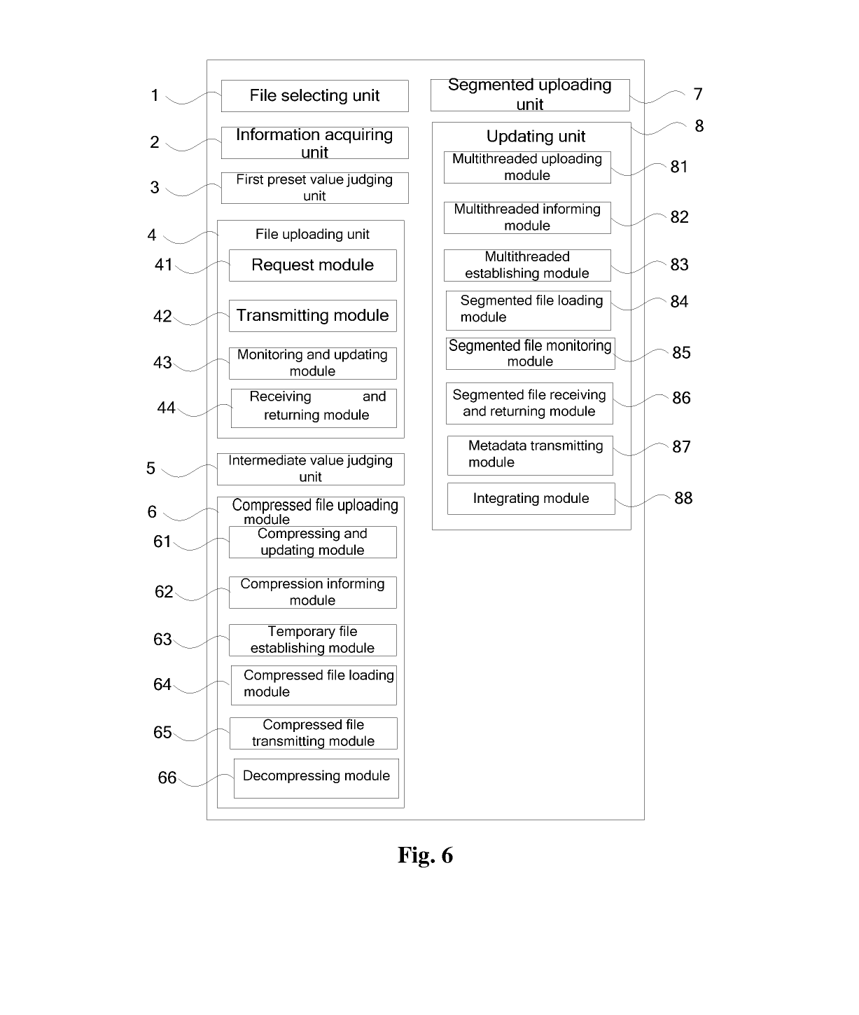

According to the embodiment, step S07 can be further detailed, and the detailed flow chart is as shown in FIG. 5. Step S07 further comprises:

Step S71: segmenting the file for the multithreaded uploading, and updating the instrument: in this step, the selected file is segmented into multiple file segments for the multithreaded uploading, and the instrument is updated.

Step S72: transmitting a request to the server from the user terminal, and informing the server to start the multithreaded uploading: in this step, the user terminal transmits a request to the server and informs the server to start the multithreaded uploading.

Step S73: creating multiple threads and temporary files according to the file size by the server, and returning the multiple uploading links: in this step, the server establishes multiple threads and temporary files according to the file size, and returns the multiple uploading links to the user terminal, namely, returning multiple uploading paths to the user terminal, i.e., the uploading path of each file segment.

Step S74: creating the user terminal threads by the user terminal according to the multiple uploading links, loading and uploading the multiple file segments: in this step, the user terminal establishes the user terminal threads according to the multiple uploading links, loads and uploads the multiple file segments.

Step S75: monitoring the bytes transmitted by various file segments by the user terminal, and updating the uploading progress of the multiple file segments displayed in the instrument panel area: in this step, the user terminal monitors the bytes transmitted by the various file segments and updates the uploading progress of the multiple file segments displayed in the instrument panel area, namely, updating the uploading progress of each file segment displayed in the instrument panel area.

Step S76: returning the uploading success information to the user terminal from the server after having received a file segment: in this step, the server, after having received a segmented file, returns the uploading success information to the user terminal.

Step S77: transmitting the metadata of the file to the server from the user terminal after having received the uploading success information of all file segments: in this step, the user terminal, after having received the uploading success information of all file segments, transmits the metadata of the file to the server.

Step S78: after the server receiving the metadata, integrating all file segments, and returning the final address of the uploaded file to the user terminal: in this step, the server, after receiving the metadata, integrates all file segments, and returns the final address of the uploaded file to the user terminal. According to the embodiment, the file larger than 20M can be uploaded in a segmented manner so as to accelerate the uploading speed and save time.

The embodiment further relates to a device for implementing the method for monitoring the file uploading via an instrument, and the structural schematic diagram is as shown in FIG. 6. According to the embodiment, the instrument comprises a setting area for setting parameters, an instrument panel area for displaying the file uploading progress, a file uploading success status area for displaying the file uploading status and a file information area for displaying the file information (Please see FIG. 2 in detail).

As shown in FIG. 6, the device comprises a file selecting unit 1, an information acquiring unit 2, a first preset value judging unit 3, a file uploading unit 4, an intermediate value judging unit 5, a compressed file uploading unit 6, a segmented uploading unit 7 and an updating unit 8, wherein the file selecting unit 1 is used for selecting a file to be uploaded by the user; the information acquiring unit 2 is used for acquiring the information of the file via the instrument, setting the maximum value of the panel according to the file size, and simultaneously displaying the metadata of the file, wherein, the metadata include the file type, the file size and the creating date; the first preset value judging unit 3 is used for judging whether the file size is smaller than a first preset value; the file uploading unit 4 is used for directly uploading the file to the server from the user terminal and monitoring the bytes transmitted by the file to update the progress displayed in the instrument panel area; returning the uploading success information after the server receiving the file; the intermediate value judging unit 5 is used for judging whether the file size is larger than the first preset value and smaller than a second preset value; according to the embodiment, the first preset value is 5M and the second preset value is 20M; certainly, under some circumstances of the embodiment, the first preset value and the second preset value can be correspondingly regulated in accordance with specific circumstances. The compressed file uploading unit 6 is used for compressing and uploading the file by the user terminal, and monitoring the bytes transmitted by the compressed file to update the progress displayed in the instrument panel area; after the server receiving the file, decompressing the compressed file, returning the uploading success information; the segmented uploading unit 7 is used for segmenting the file for the multithreaded uploading, and updating the progress of various file segments displayed in the instrument panel area according to the bytes transmitted by each file segment; after the server receiving the file, returning the uploading success information to the user terminal; the updating unit 8 is used for updating the status information in the file uploading success status area by the user terminal, thus completing file uploading. Through the instrument, the user can directly observe the file uploading progress via the instrument panel area, preview file information via the file information area and observe the file uploading success information via the file uploading success status area; therefore, the file information is displayed in a user-friendly manner, the interaction interface is good enough and experience of the user is enhanced accordingly.

According to the embodiment, the file uploading unit 4 further comprises a request module 41, a transmitting module 42, a monitoring and updating module 43 and a receiving and returning module 44, wherein the request module 41 is used for transmitting a request to the server from user terminal; the transmitting module 42 is used for transmitting the file to the server from the user terminal; the monitoring and updating module 43 is used for monitoring the bytes transmitted by the file in the user terminal in real time and updating the uploading progress displayed in the instrument panel area; the receiving and returning module 44 is used for receiving the file by the server, and returning the uploading success information to the user terminal.

According to the embodiment, the compressed file uploading unit 6 further comprises a compressing and updating module 61, a compression informing module 62, a temporary file creating module 63, a compressed file loading module 64, a compressed file transmitting module 65 and a decompressing module 66, wherein the compressing and updating module 61 is used for compressing the file to obtain a compressed file, transmitting the compressed file to the server, and simultaneously updating the instrument; the compression informing module 62 is used for transmitting a request to the server from the user terminal and informing the server to start the compressed uploading; the temporary file creating module 63 is used for creating the received temporary file by the server and returning the uploading path to the user terminal; the compressed file loading module 64 is used for loading and uploading the compressed file in accordance with the uploading path after receiving the uploading path by the user terminal; the compressed file transmitting module 65 is used for monitoring the bytes transmitted by the compressed file in the user terminal, and updating the uploading progress displayed in the instrument panel area; the decompressing module 66 is used for receiving the compressed file by the server, decompressing the compressed file and returning the uploading success information to the user terminal. By compressing the file, the uploading speed is accelerated.

According to the embodiment, the segmented uploading unit 7 further comprises a multithread uploading module 71, a multithread informing module 72, a multithread creating module 73, a segmented file loading module 74, a segmented file monitoring module 75, a segmented file receiving and returning module 76, a metadata transmitting module 77 and an integrating module 78, wherein the multithread uploading module 71 is used for segmenting the file for the multithreaded uploading, and updating the instrument; the multithread informing module 72 is used for transmitting a request to the server from the user terminal, and informing the server to start the multithreaded uploading; the multithread creating module 73 is used for creating multiple threads and temporary files according to the file size by the server, and returning the multiple uploading links; the segmented file loading module 74 is used for creating the user terminal threads by the user terminal according to the multiple uploading links, loading and uploading the multiple file segments; the segmented file monitoring module 75 is used for monitoring the bytes transmitted by the various file segments in the user terminal, and updating the uploading progress of the multiple file segments displayed in the instrument panel area; the segmented file receiving and returning module 76 is used for returning the uploading success information to the user terminal from the server after having received a file segment; the metadata transmitting module 77 is used for transmitting the metadata of the file to the server from the user terminal after having received the uploading success information of all file segments; the integrating module 78 is used for integrating all file segments after the server receiving the metadata, and returning the final address of the uploaded file to the user terminal. By segmenting the file and uploading the file segments, the uploading speed is accelerated and time is saved accordingly.

In conclusion, according to the embodiment, the file uploading progress is displayed via an instrument and the file information is previewed via the instrument; compared with the conventional file uploading, the invention will let the user have a better experiencing when uploading the file.

The foregoing embodiments are merely exemplary embodiments of the invention that will not intend to define the scope of the invention, and any modification, equivalent replacement, improvement and the like within the spirits and the principles of the invention shall be included within the protection scope of the invention.

What is claimed is:

1. A method for monitoring the file uploading via an instrument, wherein, the instrument comprises a setting area for setting parameters, an instrument panel area for displaying the file uploading progress, a file uploading success status area for displaying the file uploading status and a file information area for displaying the file information; the method comprises the following steps:
A) Selecting a file to be uploaded by the user;
B) Acquiring the information of the file via an instrument, setting the maximum value of the panel according to the file size, and simultaneously displaying the metadata of the file;
C) Judging whether the file size is smaller than a first preset value, if so, executing step D), otherwise, executing step E);
D) Directly uploading the file to the server from the user terminal and monitoring the bytes transmitted by the file to update the progress displayed in the instrument panel area; returning the uploading success information after the server receiving the file, and executing step H);
E) Judging whether the file size is larger than the first preset value and smaller than a second preset value, if so, executing step F), otherwise, executing step G);
F) Compressing and uploading the file by the user terminal, and monitoring the bytes transmitted by the compressed file to update the progress displayed in the instrument panel area; decompressing the compressed file after the server receiving the file, and returning the uploading success information, and executing step H);
G) Segmenting the file for the multithreaded uploading, and updating the progress of various file segments displayed in the instrument panel area according to the bytes transmitted by various file segments; returning the uploading success information to the user terminal after the server receiving the file, and executing step H);
H) Updating the status information in the file updating success status area by the user terminal, thus completing the file uploading.

2. The method for monitoring the file uploading via an instrument according to claim 1, wherein, the step D) further comprises:
D1) Transmitting a request to the server from the user terminal;
D2) Transmitting the file to the server from the user terminal;
D3) Monitoring the bytes transmitted by the file by the user terminal in real time and updating the uploading progress displayed in the instrument panel area;
D4) After the server receiving the file, returning the uploading success information to the user terminal.

3. The method for monitoring the file uploading via an instrument according to claim 2, wherein, the step F) further comprises:
F1) Compressing the file to obtain a compressed file, transmitting the compressed file to the server, and simultaneously updating the instrument;
F2) Transmitting a request to the server from the user terminal and informing the server to start a compressed uploading;
F3) Creating a received temporary file by the server and returning a uploading path to the user terminal;
F4) After the user terminal receiving the uploading path, loading the compressed file and uploading the compressed file in accordance with the uploading path;
F5) Monitoring the bytes transmitted by the compressed file by the user terminal, and updating the uploading progress displayed in the instrument panel area;
F6) After the server having received the compressed file, decompressing the compressed file and returning the uploading success information to the user terminal.

4. The method for monitoring the file uploading via an instrument according to claim 1, wherein, the step G) further comprises:
G1) Segmenting the file for the multithreaded uploading, and updating the instrument;
G2) Transmitting a request to the server from the user terminal, and informing the server to start the multithreaded uploading;
G3) Creating multiple threads and temporary files according to the file size by the server, and returning the multiple uploading links;
G4) Creating the user terminal threads by the user terminal in according with the multiple uploading links, loading and uploading the multiple file segments;
G5) Monitoring the bytes transmitted by the various file segments by the user terminal, and updating the uploading progress of the multiple file segments displayed in the instrument panel area;
G6) Returning the uploading success information to the user terminal from the server after having received each file segment;
G7) Transmitting the metadata of the file to the server from the user terminal as having received the uploading success information of all file segments;
G8) After the server receiving the metadata, integrating all file segments, and returning the final address of the uploaded file to the user terminal.

5. The method for monitoring the file uploading via an instrument according to claim 2, wherein, the step G) further comprises:
G1) Segmenting the file for the multithreaded uploading, and updating the instrument;
G2) Transmitting a request to the server from the user terminal, and informing the server to start the multithreaded uploading;
G3) Creating multiple threads and temporary files according to the file size by the server, and returning the multiple uploading links;
G4) Creating the user terminal threads by the user terminal in according with the multiple uploading links, loading and uploading the multiple file segments;
G5) Monitoring the bytes transmitted by the various file segments by the user terminal, and updating the uploading progress of the multiple file segments displayed in the instrument panel area;
G6) Returning the uploading success information to the user terminal from the server after having received each file segment;
G7) Transmitting the metadata of the file to the server from the user terminal as having received the uploading success information of all file segments;
G8) After the server receiving the metadata, integrating all file segments, and returning the final address of the uploaded file to the user terminal.

6. The method for monitoring the file uploading via an instrument according to claim 3, wherein, the step G) further comprises:
G1) Segmenting the file for the multithreaded uploading, and updating the instrument;
G2) Transmitting a request to the server from the user terminal, and informing the server to start the multithreaded uploading;
G3) Creating multiple threads and temporary files according to the file size by the server, and returning the multiple uploading links;
G4) Creating the user terminal threads by the user terminal in according with the multiple uploading links, loading and uploading the multiple file segments;
G5) Monitoring the bytes transmitted by the various file segments by the user terminal, and updating the uploading progress of the multiple file segments displayed in the instrument panel area;
G6) Returning the uploading success information to the user terminal from the server after having received each file segment;
G7) Transmitting the metadata of the file to the server from the user terminal as having received the uploading success information of all file segments;
G8) After the server receiving the metadata, integrating all file segments, and returning the final address of the uploaded file to the user terminal.

7. The method for monitoring the file uploading via an instrument according to claim 1, wherein, the first preset value is 5M and the second preset value is 20M; the metadata include the file type, the file size and the creating date.

8. A device for implementing the method for monitoring the file uploading via an instrument according to claim 1, wherein, the instrument comprises a setting area for setting parameters, an instrument panel area for displaying the file uploading progress, a file uploading success status area for displaying the file uploading status and a file information area for displaying the file information; the device comprises:
A file selecting unit: for selecting the file to be uploaded by the user;
An information acquiring unit: for acquiring the information of the file via an instrument, setting the maximum value of the panel according to the file size, and simultaneously displaying the metadata of the file;
A first preset value judging unit: for judging whether the file size is smaller than a first preset value;
A file uploading unit: for directly uploading the file to the server from the user terminal and monitoring the bytes transmitted by the file to update the progress displayed in the instrument panel area; returning the uploading success information after the server receiving the file;
An intermediate value judging unit: for judging whether the file size is larger than the first preset value and smaller than a second preset value;
A compressed file uploading unit: for compressing and uploading the file by the user terminal, and monitoring the bytes transmitted by the compressed file to update the progress displayed in the instrument panel area; after the server receiving the compressed file, decompressing the compressed file, and returning the uploading success information;
A segmented uploading unit: for segmenting the file for the multithreaded uploading, and updating the progress of various file segments displayed in the instrument panel area according to the bytes transmitted by each file segment; after the server receiving the file, returning the uploading success information to the user terminal;
An updating unit: for updating the status information in the file uploading success status area by the user terminal, thus completing file uploading.

9. The device for implementing the method for monitoring the file uploading via an instrument according to claim 8, wherein, the file uploading unit further comprises:
A request module: for transmitting a request to the server from the user terminal;
A transmitting module: for transmitting the file to the server from the user terminal;
A monitoring and updating module: monitoring the bytes transmitted by the file from the user terminal in real time and updating the uploading progress displayed in the instrument panel area;
A receiving and returning module: for receiving the file by the server, and returning the uploading success information to the user terminal.

10. The device for implementing the method for monitoring the file uploading via an instrument according to claim 9, wherein, the compressed file uploading unit further comprises:
A compressing and updating module: for compressing the file to obtain a compressed file, transmitting the compressed file to the server, and simultaneously updating the instrument;
A compression informing module: for transmitting a request to the server from the user terminal and informing the server to start the compressed uploading;
A temporary file creating module: for creating the received temporary file by the server and returning the uploading path to the user terminal;
A compressed file loading module: for loading and uploading the compressed file in accordance with the uploading path, after the user terminal receiving the uploading path;
A compressed file transmitting module: for monitoring the bytes transmitted by the compressed file by the user terminal, and updating the uploading progress displayed in the instrument panel area;
A decompressing module: for receiving the compressed file by the server, decompressing the compressed file and returning the uploading success information to the user terminal.

11. The device for implementing the method for monitoring the file uploading via an instrument according to claim 8, wherein, the segmented uploading unit further comprises:
A multithread uploading module: for segmenting the file for the multithreaded uploading, and updating the instrument;
A multithread informing module: for transmitting a request to the server by the user terminal, and informing the server to start the multithreaded uploading;
A multithread creating module: for creating multiple threads and temporary files according to the file size by the server, and returning the multiple uploading links;
A segmented file loading module: for creating the user terminal threads by the user terminal according to the multiple uploading links, loading and uploading the multiple file segments;
A segmented file monitoring module: for monitoring the bytes transmitted by the various file segments by the user terminal, and updating the uploading progress of the multiple file segments displayed in the instrument panel area;
A segmented file receiving and returning module: for returning the uploading success information to the user terminal from the server after having received a segmented file;
A metadata transmitting module: for transmitting the metadata of the file to the server from the user terminal after having received the uploading success information of all file segments;
An integrating module: for integrating all file segments after the server receiving the metadata, and returning the final address of the uploaded file to the user terminal.

12. The device for implementing the method for monitoring the file uploading via an instrument according to claim 9, wherein, the segmented uploading unit further comprises:
A multithread uploading module: for segmenting the file for the multithreaded uploading, and updating the instrument;
A multithread informing module: for transmitting a request to the server by the user terminal, and informing the server to start the multithreaded uploading;
A multithread creating module: for creating multiple threads and temporary files according to the file size by the server, and returning the multiple uploading links;
A segmented file loading module: for creating the user terminal threads by the user terminal according to the multiple uploading links, loading and uploading the multiple file segments;
A segmented file monitoring module: for monitoring the bytes transmitted by the various file segments by the user terminal, and updating the uploading progress of the multiple file segments displayed in the instrument panel area;
A segmented file receiving and returning module: for returning the uploading success information to the user terminal from the server after having received a segmented file;
A metadata transmitting module: for transmitting the metadata of the file to the server from the user terminal after having received the uploading success information of all file segments;
An integrating module: for integrating all file segments after the server receiving the metadata, and returning the final address of the uploaded file to the user terminal.

13. The device for implementing the method for monitoring the file uploading via an instrument according to claim 10, wherein, the segmented uploading unit further comprises:
A multithread uploading module: for segmenting the file for the multithreaded uploading, and updating the instrument;
A multithread informing module: for transmitting a request to the server by the user terminal, and informing the server to start the multithreaded uploading;
A multithread creating module: for creating multiple threads and temporary files according to the file size by the server, and returning the multiple uploading links;
A segmented file loading module: for creating the user terminal threads by the user terminal according to the multiple uploading links, loading and uploading the multiple file segments;
A segmented file monitoring module: for monitoring the bytes transmitted by the various file segments by the user terminal, and updating the uploading progress of the multiple file segments displayed in the instrument panel area;
A segmented file receiving and returning module: for returning the uploading success information to the user terminal from the server after having received a segmented file;
A metadata transmitting module: for transmitting the metadata of the file to the server from the user terminal after having received the uploading success information of all file segments;
An integrating module: for integrating all file segments after the server receiving the metadata, and returning the final address of the uploaded file to the user terminal.

14. The device for implementing the method for monitoring the file uploading via an instrument according to claim 8, wherein, the first preset value is 5M and the second preset value is 20M; the metadata include the file type, the file size and the creating date.
